(19) United States
(12) Patent Application Publication
(10) Pub. No.: US 2014/0248095 A1
(43) Pub. Date: Sep. 4, 2014

(54) DEVICE FOR PNEUMATICALLY CONVEYING POWDER AND METHOD FOR CLEANING SUCH A DEVICE

(71) Applicants: Hanspeter Michael, Gossau (CH); Marco Sanwald, Abtwil (CH)

(72) Inventors: Hanspeter Michael, Gossau (CH); Marco Sanwald, Abtwil (CH)

(21) Appl. No.: 14/007,187

(22) PCT Filed: Feb. 15, 2012
(86) PCT No.: PCT/US12/25199

§ 371 Date: Dec. 14, 2013

(30) Foreign Application Priority Data
Feb. 18, 2011 (DE) 102011004352.7

(51) Int. Cl. B65G 45/22; B65G 53/34

(52) U.S. Cl. CPC B65G 45/22; B65G 53/34
USPC 406/46

(57) ABSTRACT

The invention relates to a device for pneumatically conveying powder, the device having an injector with a conveying gas connection and a metering gas connection as well as a powder intake channel connected in terms of flow to the injector. To achieve the effect that the powder conveying device can be effectively flushed through in the cleaning mode of said device, it is provided according to the invention that a purging gas connection, which is connected or can be connected to a purging gas line, is provided between the negative pressure region of the injector and the powder intake opening of the powder intake channel for the feeding, as and when required, of purging gas, in particular compressed purging air. Furthermore, a shut-off element is assigned to the purging gas connection to prevent purging gas from being able to escape from the powder output opening of the powder intake channel.

The invention relates to a device for pneumatically conveying powder or powdered material according to the preamble of independent patent claim 1.

Accordingly, the invention relates in particular to a device for pneumatically conveying powder or powdered material, in particular coating powder, the device having at least one injector, which has a conveying gas connection, which is connected or can be connected in terms of flow to a conveying gas line and is intended for the regulated feeding of conveying gas, in particular conveying air, and has a metering gas connection, which is connected or can be connected to a metering gas line and is intended for the regulated feeding of metering gas, in particular metering air, the conveying gas being fed to the injector in such a way that a negative pressure region is formed in the injector. The pneumatic powder conveying device of the type in question also has a powder intake channel, which is connected or can be connected in terms of flow to the at least one injector and has at its powder input a powder intake opening for taking in the powder to be conveyed.

The invention also relates to a powder supply device for a powder coating installation, the powder supply device having at least one pneumatic powder conveying device of the aforementioned type and at least one powder container with a powder chamber for coating powder.

Finally, the invention also relates to a method for cleaning a pneumatic powder conveying device of the aforementioned type.

Injectors for pneumatically conveying coating powder from a powder container to a spraying device are generally known in principle, for example from powder coating technology. Spraying devices to which coating powder is pneumatically conveyed with the aid of injectors may take the form of manually actuable guns or automatically controlled spraying devices. Depending on the desired spraying method, the spraying device may be variously formed, as documents U.S. Pat. No. 3,521,815 A, U.S. Pat. No. 4,802,625 A or U.S. Pat. No. 4,788,933 A show.

The two last-mentioned documents disclose spraying devices to which cleaning gas can be fed in addition to the powder-gas stream, which gas flows by way of electrodes for the electrostatic charging of the coating powder and thereby cleans these electrodes and keeps them free of contaminating effects caused by powder deposits. The high voltage for the electrodes can be generated in a known way by a high-voltage generator contained in the spraying device or by an external high-voltage generator. The high voltage of the high-voltage generator produces an electrostatic field between the electrodes and an object to be coated, which is earthed, along which field the particles of the coating powder fly from the coating device to the object.

In order to achieve a constant conveyed stream of the powder-air mixture, the air velocity in the fluid lines, that is in particular in the powder conveying hoses, must preferably assume a value between 10 and 15 m/s. At a lower air velocity in the fluid line, the powder conveyance becomes irregular; there is a pulsation of the powder-air mixture, which propagates to the powder outlet at the spraying device. At higher air velocities, the electrostatic charging of the coating powder onto the object to be coated is impaired very greatly, because there is then the risk of powder that has already been deposited on the object being blown away again.

Depending on the requirements of the coating operation, the amount of powder fed to the spraying device is increased or reduced. A practical value for the amount of powder fed per unit of time is 300 g/min. If the amount of powder fed per unit of time has to be reduced, first the pressure of the conveying air fed to the injector is reduced. This also reduces the flow rate of the conveying air in the fluid lines. However, the total amount of air must neither become too low nor exceed a maximum value. In order to compensate for this reduction in the amount of air, that is to say at least to get back to an air velocity of 10 m/s, while retaining the reduced powder discharge, more metering air is fed to the injector. The known function of the injectors is as follows:

The conveying air produces a negative pressure in the injector, by which coating powder is taken in from a powder container, picked up by the conveying air and fed to the spraying device through fluid lines. By changing the pressure, and consequently also the amount, of the conveying air, the amount of coating powder conveyed per unit of time can be set. Since the conveying rate is dependent on the level of the negative pressure produced in the injector by the conveying air, with constant or variable conveying air the conveying air can also be regulated by introducing metering air into the negative pressure region of the injector, in order in this way to change the level of the negative pressure to correspond to the desired amount of powder conveyed. This means that the amount of powder conveyed is not just dependent on the amount of conveying air, but on the difference of the conveying air minus the metering air. However, for the aforementioned reasons, the total amount of air that transports the coating powder must remain constant for a specific coating operation.

A pneumatic powder conveying device of the type mentioned at the beginning, i.e. a device which has at least one injector that assumes the function of a powder pump and pneumatically feeds coating powder to a spraying device, is suitable in particular for supplying powder to a powder coating installation which is used for the electrostatic spray coating of objects with powder and in which fresh coating powder (hereafter also referred to as “fresh powder”) and possibly recovered coating powder (hereafter also referred to as “recovery powder”) are located in the powder container and are fed to a spraying device by a pneumatic powder conveying device of the type mentioned at the beginning. As already indicated, the spraying device may be, for example, a handheld gun or an automatic gun.

As and when required, fresh powder is fed from a supplier's container, in which the powder supplier supplies the fresh powder to the powder user, to the powder container by way of a fresh powder line.

In the supplier's container, the powder forms a compact mass. By contrast, the coating powder in the powder container should be in a fluidized state, in order that it can be sucked out by the suction effect of the at least one injector used in the pneumatic powder conveying device and fed to the spraying device in a stream of compressed air. A powder supplying device consequently includes in particular a powder container which serves as a powder chamber for keeping coating powder, the coating powder usually being fluidized in the powder container in order that it can be pneumatically conveyed easily, either to another powder container or to a powder spraying device. As already stated, the powder spraying device may be a manual or automatic powder spraying device, which has a spray nozzle or a rotary atomizer.

The invention addresses the problematic situation that powder coating installations, and in particular the pneumatic powder conveying devices used in powder conveying installations, must be carefully cleaned in the event of a change of powder (change from one kind of powder to another kind of powder), in particular in the event of a color change (change from a powder of a first color to a powder of a different color), since even a few powder particles of the previous kind of powder can result in coating imperfections during the coating with the new kind of powder.

The invention is accordingly intended to achieve the object of providing a possible way in which a change of powder is quickly possible in a simple manner.

With regard to the pneumatic powder conveying device, this object is achieved according to the invention by the features of independent patent claim 1. With regard to a method for the optionally automatic cleaning of a pneumatic powder conveying device, in particular in the event of a change of color or powder, the object on which the invention is based is achieved by the subject matter of independent patent claim 15.

Accordingly proposed in particular is a pneumatic powder conveying device which has at least one injector and a powder intake channel which is connected or can be connected to the at least one injector, the powder intake channel having at its powder input a powder intake opening for taking in the powder to be conveyed. The at least one injector of the pneumatic powder conveying device according to the invention has a conveying gas connection, which is connected or can be connected in terms of flow to a conveying gas line and is intended for the regulated feeding of conveying gas, in particular conveying air, and has a metering gas connection, which is connected or can be connected to a metering gas line and is intended for the regulated feeding of metering gas, in particular metering air, the negative pressure region necessary for taking in the powder to be conveyed being formed in the injector on the Venturi principle with the aid of the conveying gas fed to the injector. According to the invention, it is provided that a purging gas connection, which is connected or can be connected in terms of flow to a purging gas line, is provided between the negative pressure region of the injector and the powder intake opening of the powder intake channel for the feeding, as and when required, of purging gas, in particular purging air. In addition to this purging gas connection, according to the teachings of the invention it is provided that an activatable or direction-bound shut-off element is provided between the purging gas connection and the powder intake opening of the powder intake channel and can be used to prevent either optionally or automatically the purging gas that is fed to the purging gas connection from being able to escape from the powder output opening of the powder intake channel.

The advantages that can be achieved with the invention are obvious: the provision of the additional purging gas connection with the assigned shut-off element makes it possible in the cleaning mode of the pneumatic powder spraying device to additionally introduce purging gas, in particular purging air, into the system (injector and a powder line, possibly connected thereto, with the spraying device connected in terms of flow to said line), in order to flush through, and consequently clean, particularly effectively the pneumatic powder conveying device and a powder line possibly connected in terms of flow to the at least one injector of the powder conveying device. In the case of conventional powder supply devices, in which the injector does not have an additional purging gas connection with an associated shut-off element, in the cleaning mode it is only possible to introduce gas, in particular compressed air, for the cleaning of the system by way of the metering gas connection and the conveying gas connection of the at least one injector, the amount of gas that can be introduced per unit of time only by way of the metering gas connection and the conveying gas connection not being sufficient under some circumstances to flush through the pneumatic powder conveying device, and in particular a powder line connected in terms of flow to the injector of the powder conveying device, such that no residual powder remains any longer in the system. The fact that, in the case of the solution according to the invention, not only a greater amount of gas can be introduced per unit of time by way of the additional purging gas connection for the purpose of cleaning the system but also a shut-off element assigned to the purging gas connection is provided between the purging gas connection and the powder intake opening of the powder intake channel ensures that the amount of purging gas introduced by way of the purging gas connection can completely flush through the at least one injector of the powder conveying device and the powder line possibly connected in terms of flow to the at least one injector. In other words, the solution according to the invention is distinguished by the fact that, for the purpose of cleaning the pneumatic powder conveying device, additional purging gas (preferably compressed air) can be introduced into the powder intake channel which is connected or can be connected in terms of flow to the injector, the shut-off element (valve) assigned to the purging gas connection preventing purging gas from flowing in the direction of the injector intake.

In this way, the powder conveying device according to the invention has a cleaning function (purge function) which makes it possible that a sufficiently great amount of purging gas can be fed to the system (injector), and to the powder line possibly connected to the injector, to produce in particular the effect of cleaning with regard to the elimination of “bridge formations” (short-circuits in the processing of metallic powders) and “hose additions” (caused by atmospheric moisture). With the solutions known from the prior art, it is particularly not possible, for cleaning or flushing through the injector and the powder line with the spraying device possibly connected thereto, to purge with a total of 30 standard cubic meters of gas, which however is required to allow all of the powder residues to be effectively eliminated.

Advantageous developments of the powder conveying device according to the invention are specified in claims 2 to 12.

Thus, in a particularly preferred implementation of the solution according to the invention, it is provided that the injector has a powder input, by way of which the coating powder taken in through the powder intake opening of the powder intake channel is fed to the injector, the purging gas connection with the associated shut-off element being arranged between the powder input of the injector and the powder output of the powder intake channel. The powder input of the injector may be formed, for example, by a stub or a stub-like inlet of the injector. With this implementation of the pneumatic powder conveying device, it is preferred if the purging gas connection and the associated shut-off element are formed as a subassembly, which is preferably releasably connected to the powder input of the injector. In addition to this, it is also appropriate that the subassembly comprising the purging gas connection and the assigned shut-off element is also connected, preferably releasably, to the powder output of the powder intake channel.

Combining the purging gas connection and the associated shut-off element to form a single subassembly makes it possible to retrofit already existing injectors in order to provide the pneumatic powder conveying device in which the conventional injectors are used with the purging feature according to the invention.

A releasable connection of the subassembly comprising the purging gas connection and the assigned shut-off element to the powder output of the powder intake channel additionally has the further advantage that, in the cleaning mode of the pneumatic powder conveying device, the powder intake channel and the injector with the powder line possibly connected thereto and the spraying device can be cleaned separately from one another. This increases the flexibility and reduces the period of time to be set aside for the cleaning mode.

In a particularly preferred embodiment of the solution according to the invention, the shut-off element assigned to the powder intake channel is formed as an activatable valve, in particular as an activatable pinch valve, in order, as and when required, to prevent a stream of purging gas in the direction of intake. The forming of the shut-off element as an activatable valve (preferably a pinch valve) has the advantage that purging gas can be introduced into the system by way of the purging gas connection, this introduced purging gas only serving for purging the injector and the powder line, possibly connected to the injector, with the spraying device when the activatable valve is closed, although the introduced purging gas may also be used for purging, and consequently cleaning, the powder intake channel when the activatable valve is open.

As an alternative to a shut-off element configured as an activatable valve, it is conceivable to form the shut-off element as a direction-bound non-return valve, which shuts off gas flows from the purging gas connection in the direction of the powder output opening of the powder intake channel. Such a direction-bound non-return valve represents a particularly easy-to-implement but nevertheless effective solution for ensuring that the purging gas introduced into the system by way of the purging gas connection cannot flow in the direction of the injector intake. Of course, other embodiments are also conceivable for the shut-off element assigned to the purging gas connection.

In principle, it is of advantage if the conveying gas connection of the at least one injector and the metering gas connection of the at least one injector are respectively assigned a shut-off element, in particular a direction-bound non-return valve, in order to prevent, in particular in the cleaning mode, the purging gas that is introduced into the system from being able to escape by way of the metering gas connection or conveying gas connection into the gas lines connected to these connections, and consequently from the system. Instead of a direction-bound non-return valve, however, it is also conceivable for example to provide an activatable valve for the shut-off element assigned to the metering gas connection and the conveying gas connection.

For effective cleaning of the pneumatic powder conveying device, it has been found that it is of advantage if the gas introduced into the injector for cleaning or purging (purging gas, conveying gas and/or metering gas) is introduced in a pulsed manner, since in this way any powder particles that may be adhering to inner walls of the injector or to the inner wall of the powder line can be detached particularly effectively. It should be taken into consideration here that a not entirely insignificant boundary layer may form if the system is flushed through with a continuous stream of purging gas. On account of this boundary layer then occurring, particles adhering to inner walls of the injector or to the inner wall of the powder line possibly connected to the injector often cannot be detached.

In order to be able in the cleaning mode of the pneumatic powder conveying device to introduce the gas intended for cleaning or flushing through (compressed gas) into the system in a pulsed manner, in an advantageous implementation of the solution according to the invention an activatable valve is provided, in particular an activatable spring-loaded 2/2-way valve, which valve is connected or can be connected in terms of flow to the purging gas line and can be activated by way of a control device in such a way that the purging gas can be fed in a pulsed manner, in particular in the cleaning mode of the pneumatic powder conveying device. In addition to this, it is of advantage if at least one further activatable valve, in particular a further activatable spring-loaded 2/2-way valve, is provided, which valve is connected or can be connected in terms of flow to the conveying gas line and/or the metering gas line and can be activated by way of the control device in such a way that conveying gas and/or metering gas are/is fed in a pulsed manner, in particular in the cleaning mode of the pneumatic powder conveying device. Here it is conceivable that an activatable valve is respectively provided both for the conveying gas line and for the metering gas line. As an alternative to this, however, it is also conceivable to provide a common activatable valve both for the conveying gas line and for the metering gas line, this common activatable valve being arranged in the compressed-gas line system from which the conveying gas line and the metering gas line extend.

Further advantages, features and modifications of the pneumatic powder conveying device are specified in the other dependent patent claims 2 to 12.

The powder conveying device according to the invention is suitable in particular for use in a powder supply device for a powder coating installation, in which there is provided in addition to the pneumatic powder conveying device at least one powder container with a powder chamber for coating powder, the powder intake opening of the powder intake channel, which is connected or can be connected to the at least one injector of the pneumatic powder conveying device, opening out in the powder chamber.

The invention not only relates to the previously described pneumatic powder conveying device but also to a method for cleaning such a powder conveying device, in particular in the event of a change of color or powder.

The method according to the invention is distinguished by the fact that first metering gas, in particular metering air, is continuously fed by way of the metering gas connection of the injector and/or conveying gas, in particular conveying air, is continuously fed by way of the conveying gas connection of the injector, to be precise for a previously specified or specifiable time period, in order to be able to bring about emptying of a powder line connected in terms of flow to the injector. Depending on the length of the powder line connected to the injector, the continuous feeding of metering gas and/or conveying gas is necessary for a time period of 1 s to 3 s.

Once the powder line has been emptied by the continuous feeding of metering gas and/or conveying gas, purging gas is fed in a pulsed manner by way of the purging gas connection of the injector. At the same time or after some time delay, metering gas is fed to the injector, by way of the metering gas connection, and conveying gas is fed to the injector, preferably by way of the conveying gas connection, in each case in a metered manner.

The pulsed feeding of the purging gas and the pulsed feeding of the metering gas and/or conveying gas should preferably take place in the same phase, in order that the purging gas and the metering gas and/or conveying gas are respectively introduced at the same point in time. In this way, particularly thorough and effective cleaning of the system is possible. It is also preferred in this connection if the lengths of the pulses during which the purging gas is fed and the lengths of the pulses during which the metering gas and/or conveying gas is fed are different. In a preferred implementation of the cleaning method according to the invention, it is provided in this respect that the pulse lengths for the feeding of the purging gas are longer than the pulse lengths for the feeding of the metering gas and/or conveying gas.

With regard to the pulsed feeding of the purging gas, metering gas and/or conveying gas, it has also proven to be advantageous if the pulsed feeding takes place in different phases, these phases differing in the frequency with which the purging gas and the metering gas and/or conveying gas are fed.

Finally, in a preferred implementation of the cleaning method according to the invention, it is provided that electrode purging gas is fed in a pulsed manner to a spraying device connected in terms of flow to the injector by way of the powder line, in order to clean electrodes of the spraying device.

Exemplary embodiments of the solution according to the invention are described below with reference to the accompanying drawings, in which:

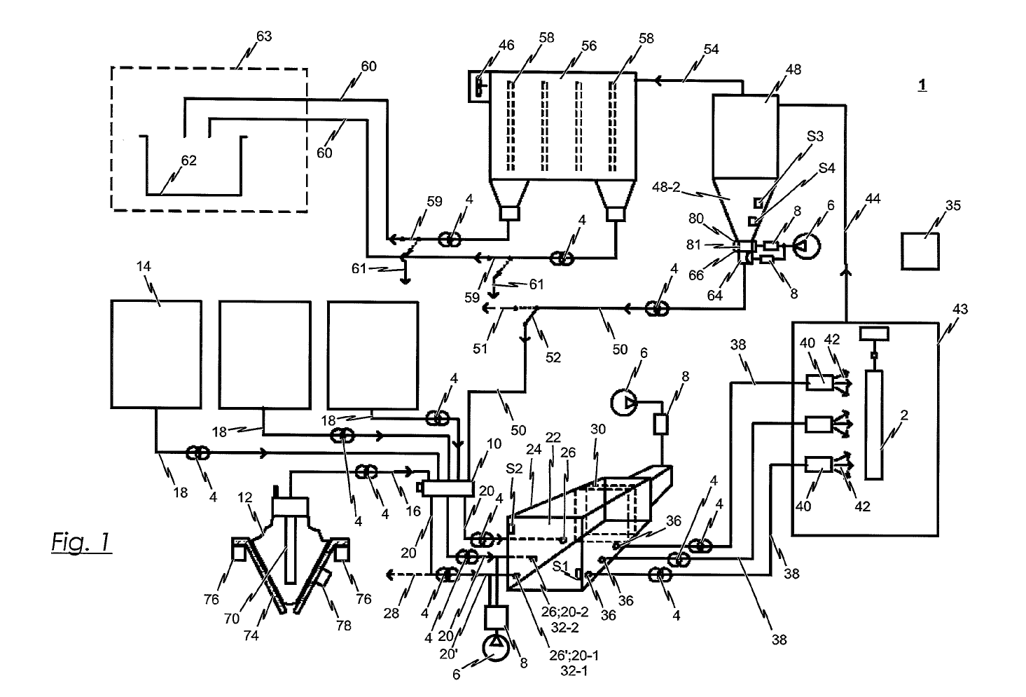

FIG. 1 schematically shows a powder coating installation with a powder supply device in which a pneumatic powder conveying device according to the invention is used;

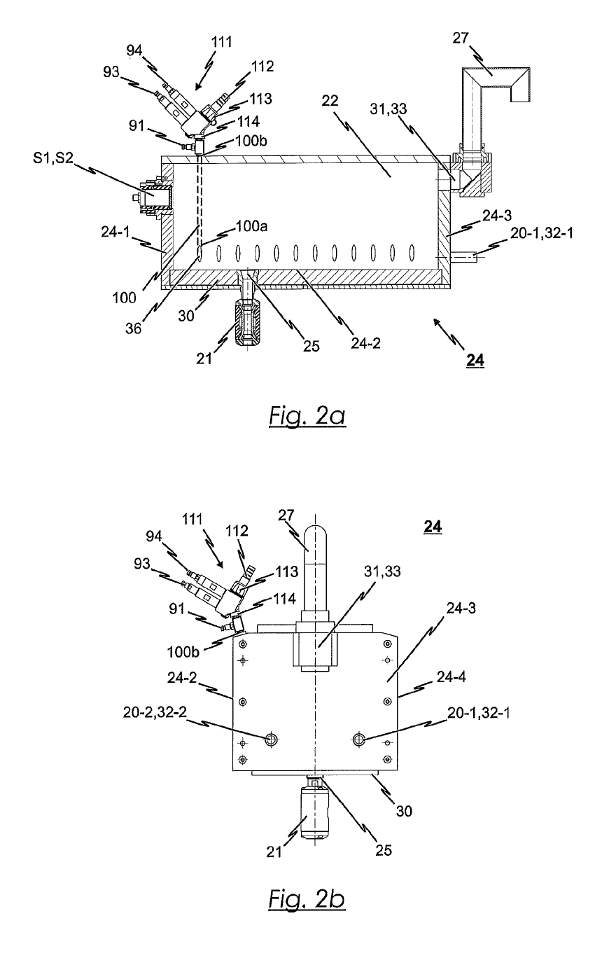

FIG. 2a shows a longitudinal sectional side view of a powder container according to an exemplary embodiment of a powder supply device in which the powder conveying device according to the invention is used;

FIG. 2b shows a view of the end face of the powder container according to FIG. 2a;

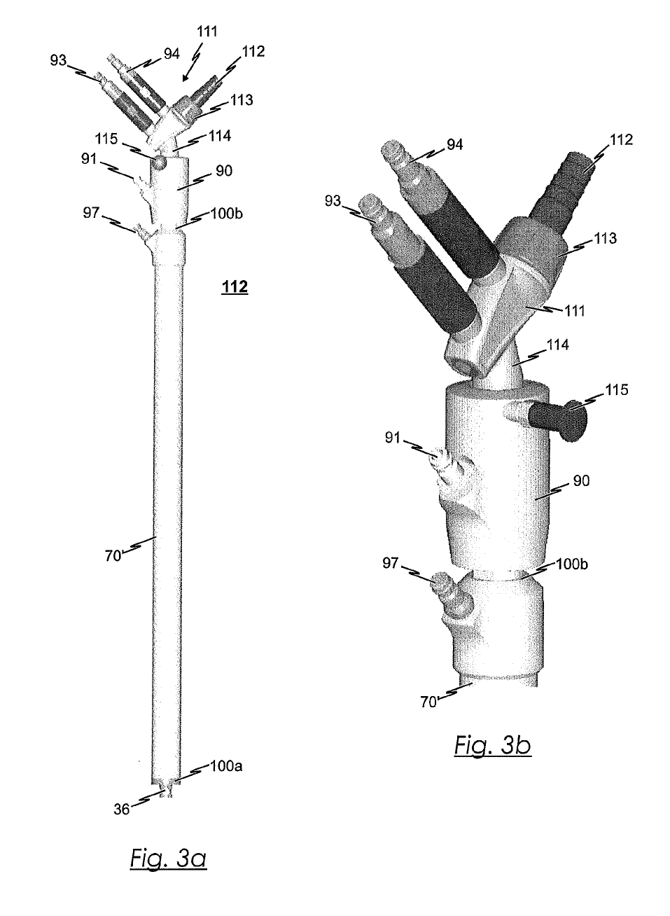

FIG. 3a shows a side view of an exemplary embodiment of the powder conveying device according to the invention;

FIG. 3b shows a perspective view of the upper region of the powder conveying device represented in FIG. 3a;

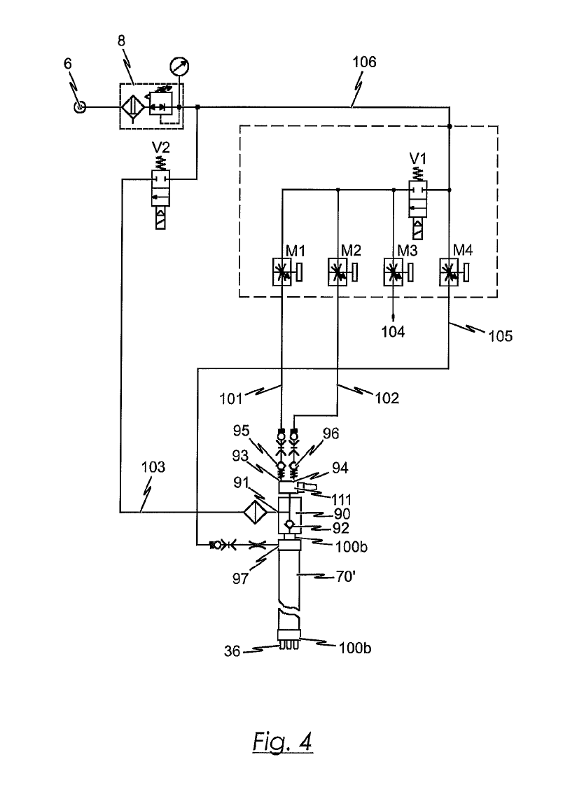

FIG. 4 shows a pneumatic diagram for an exemplary embodiment of the powder conveying device according to the invention;

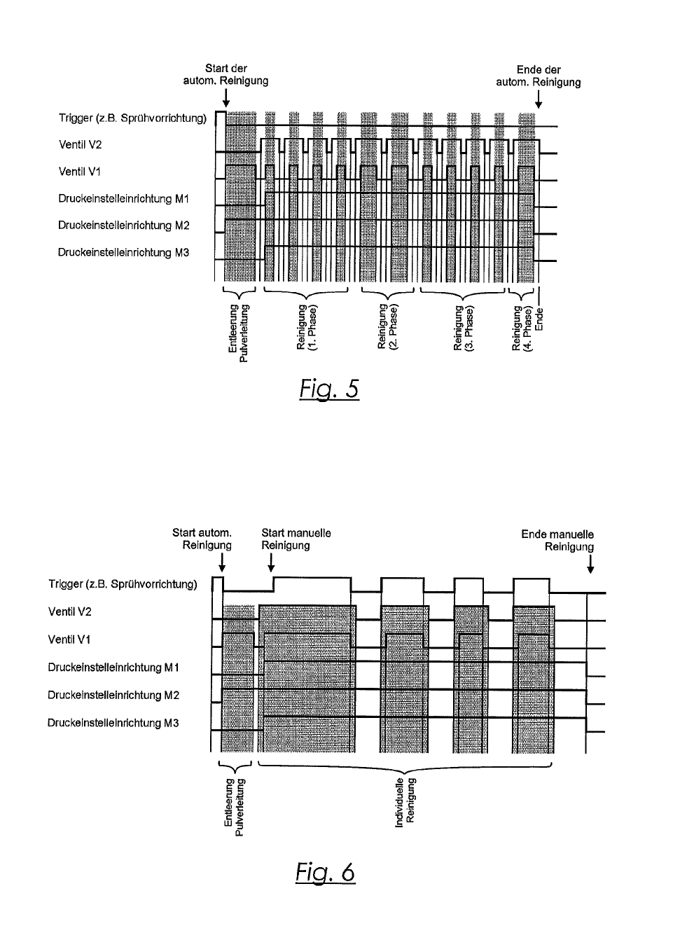

FIG. 5 shows an overview of the time sequence of the gas flows fed to the injector of a powder conveying device in the automatic cleaning mode; and

FIG. 6 shows an overview of the time sequence of the gas flows fed to the injector of a powder conveying device in the semiautomatic cleaning mode.

FIG. 1 schematically shows an exemplary embodiment of a powder coating installation 1 for the spray coating of objects 2 with coating powder, which after that is fused onto the objects 2 in a heating furnace not represented in FIG. 1. One or more electronic control devices 35 are provided for controlling the function of the powder coating installation 1.

Powder pumps 4 are provided for pneumatically conveying the coating powder. These pumps may be injectors into which coating powder is sucked out of a powder container by means of compressed air serving as conveying air, after which the mixture of conveying air and coating powder together flows into a container or to a spraying device.

Suitable injectors are known, for example, from the document EP 0 412 289 B1.

It is possible also to use as the powder pump 4 those types of pump which convey small portions of powder one after the other by means of compressed air, a small portion of powder (amount of powder) being respectively stored in a powder chamber and then forced out of the powder chamber by means of compressed air. The compressed air remains behind the portion of powder and pushes the portion of powder in front of it. These types of pump are sometimes referred to as compressed-air feed pumps or plug-conveying pumps, since the compressed air pushes the stored portion of powder in front of it through a pump outlet line like a plug. Various types of such powder pumps for conveying dense coating powder are known, for example, from the following documents: DE 103 53 968 A1, U.S. Pat. No. 6,508,610 B2, US 2006/0193704 A1, DE 101 45 448 A1 or WO 2005/051549 A1.

To generate the compressed air for the pneumatic conveyance of the coating powder and to fluidize the coating powder, a compressed air source 6 is provided, connected to the various devices by way of corresponding pressure setting elements 8, for example pressure controllers and/or valves.

Fresh powder from a powder supplier is fed from a supplier's container, which may be for example a small container 12, for example in the form of a dimensionally stable container or a sack with an amount of powder of for example between 10 and 50 kg, for example 35 kg, or for example a large container 14, for example likewise a dimensionally stable container or a sack, with an amount of powder between for example 100 kg and 1000 kg, by means of a powder pump 4 in a fresh powder line 16 or 18 to a screening device 10. The screening device 10 may be provided with a vibrator 11. In the following description, the expressions “small container” and “large container” each mean both a “dimensionally stable container” and a “not dimensionally stable, flexible sack”, unless reference is expressly made to one or the other type of container.

The coating powder screened by the screening device 10 is conveyed by gravitational force, or preferably in each case by a powder pump 4, by way of one or more powder supply lines 20, 20′ through powder-inlet openings 26, 26′ into a powder chamber 22 of a dimensionally stable powder container 24. The volume of the powder chamber 22 is preferably much smaller than the volume of the small fresh-powder container 12.

According to a conceivable implementation of the solution according to the invention, the powder pump 4 of the at least one powder supply line 20, 20′ to the powder container 24 is a compressed-air feed pump. Here, the initial portion of the powder supply line 20 may serve as a pump chamber into which powder screened by the screening device 10 falls through a valve, for example a pinch valve. Once this pump chamber contains a certain portion of powder, the powder supply line 20 is isolated in terms of flow by closing the valve of the screening device 10. After that, the portion of powder is pushed into the powder chamber 22 by means of compressed air through the powder supply line 20, 20′.

Powder pumps 4, for example injectors, for conveying coating powder through powder lines 38 to spraying devices 40 are connected to one or preferably a number of powder outlet opening(s) 36 of the powder container 24. The spraying devices 40 may be spray nozzles or rotary atomizers for spraying the coating powder 42 onto the object 2 to be coated, which is preferably located in a coating cubicle 43.

The powder outlet openings 36 may be located—as represented in FIG. 1—in a wall of the powder container 24 that lies opposite the wall in which the powder inlet openings 26, 26′ are located. In the case of the embodiment of the powder container 24 represented in FIG. 2a and FIG. 2b, however, the powder outlet openings 36 are arranged in a wall which is adjacent to the wall in which the powder inlet openings 26, 26′ are located. The powder outlet openings 36 are preferably arranged near the bottom of the powder chamber 22.

The powder chamber 22 is preferably of a size that lies in the range of a coating powder capacity of between 1.0 kg and 12.0 kg, preferably between 2.0 kg and 8.0 kg. According to other aspects, the size of the powder chamber 22 is preferably between 500 cm³ and 30 000 cm³, preferably between 2000 cm³ and 20 000 cm³. The size of the powder chamber 22 is chosen in dependence on the number of powder outlet openings 36 and the powder lines 38 connected thereto, in such a way that continuous spray coating operation is possible, but the powder chamber 22 can be quickly cleaned, preferably automatically, during coating breaks for changing the powder.

The powder chamber 22 may be provided with a fluidizing device 30 for fluidizing the coating powder received in the powder container 24. The fluidizing device 30 contains at least one fluidizing wall of a material with open pores or with narrow bores, which is permeable to compressed air but not to coating powder. Although not shown in FIG. 1, it is of advantage if in the case of the powder container 24 the fluidizing wall forms the bottom of the powder container 24 and is arranged between the powder chamber 22 and a fluidizing compressed-air chamber. The fluidizing compressed-air chamber should be able to be connected to the compressed air source 6 by way of a pressure setting element 8.

Coating powder 42 that does not adhere to the object 2 to be coated is sucked into a cyclone separator 48 as excess powder by means of a stream of suction air of a blower 46 by way of an excess powder line 44. In the cyclone separator 48, the excess powder is separated as far as possible from the stream of suction air. The separated powder fraction is then conducted as recovery powder from the cyclone separator 48 by way of a powder recovery line 50 to the screening device 10, where it passes through the screening device 10, either alone or mixed with fresh powder, by way of the powder supply lines 20, 20′ back into the powder chamber 22.

Depending on the kind of powder and/or the degree of powder contamination, the possibility of isolating the powder recovery line 50 from the screening device 10 and conducting the recovery powder into a waste container may also be provided, as schematically represented in FIG. 1 by a dashed line 51. In order that it need not be isolated from the screening device 10, the powder recovery line 50 may be provided with a diverter 52, at which it can be connected alternatively to the screening device 10 or to a waste container.

The powder container 24 may have one or more, for example two, sensors S1 and/or S2, in order to control the supply of coating powder into the supply chamber 22 by means of the control device 3 and the powder pumps 4 in the powder supply lines 20, 20′. For example, the lower sensor S1 detects a lower powder level limit and the upper sensor S2 detects an upper powder level limit.

The lower end portion 48-2 of the cyclone separator 48 may be formed and used as a storage container for recovery powder and provided for this purpose with one or more, for example two, sensors S3 and S4, which are functionally connected to the control device 3. This allows, for example, the feeding of fresh powder through the fresh powder supply lines 16 and 18 to be automatically stopped as long as there is sufficient recovery powder in the cyclone separator 48 to feed recovery powder to the powder chamber 22 through the screening device 10 in a sufficient amount required for the spray coating operation by means of the spraying devices 40. If there is no longer sufficient recovery powder in the cyclone separator 48, it is possible to switch over automatically to the feeding of fresh powder through the fresh powder supply lines 16 or 18. Furthermore, there is also the possibility of feeding fresh powder and recovery powder to the screening device 10 at the same time, so that they are mixed with each other.

The exhaust air of the cyclone separator 48 passes by way of an exhaust-air line 54 into an after-filtering device 56 and through one or more filter elements 58 therein to the blower 46 and after that into the outside atmosphere. The filter elements 58 may be filter bags or filter cartridges or filter plates or similar filter elements. The powder separated from the stream of air by means of the filter elements 58 is normally waste powder and falls by gravitational force into a waste container or, as shown in FIG. 1, may be conveyed by way of one or more waste lines 60, which each contain a powder pump 4, into a waste container 62 at a waste station 63.

Depending on the kind of powder and the powder coating conditions, the waste powder may also be recovered again to the screening device 10, to re-enter the coating cycle. This is schematically represented in FIG. 1 by diverters 59 and branch lines 61 of the waste lines 60.

In the case of multi-color operation, in which different colors are respectively sprayed only for a short time, the cyclone separator 48 and the after-filtering device 56 are usually used and the waste powder of the after-filtering device 56 passes into the waste container 62. Although the powder separating efficiency of the cyclone separator 48 is usually less than that of the after-filtering device 56, it can be cleaned more quickly than the after-filtering device 56. In the case of single-color operation, in which the same powder is used for a long time, it is possible to dispense with the cyclone separator 48 and to connect the excess powder line 44 to the after-filtering device 56 instead of the exhaust-air line 54, and to connect the waste lines 60, which in this case contain powder to be recovered, as recovery powder lines to the screening device 10.

In the case of single-color operation, the cyclone separator 48 is usually only used in combination with the after-filtering device 56 when a problematic coating powder is involved. In this case, only the recovery powder of the cyclone separator 48 is fed to the screening device 10 by way of the powder recovery line 50, while the waste powder of the after-filtering device 56 passes as waste into the waste container 62 or into some other waste container, which latter can be placed directly under an outlet opening of the after-filtering device 56 without waste lines 60.

The lower end of the cyclone separator 48 may have an outlet valve 64, for example a pinch valve. Furthermore, a fluidizing device 66 for fluidizing the coating powder may be provided above this outlet valve 64, in or at the lower end of the lower end portion 48-2, formed as a storage container, of the cyclone separator 48. The fluidizing device 66 contains at least one fluidizing wall 80 of a material which has open pores or is provided with narrow bores and is permeable to compressed air but not to coating powder. The fluidizing wall 80 is arranged between the powder path and a fluidizing compressed-air chamber 81. The fluidizing compressed-air chamber 81 can be connected to the compressed air source 6 by way of a pressure setting element 8.

The fresh powder line 16 and/or 18 may be connected in terms of flow at its upstream end, either directly or through the powder pump 4, to a powder conveying tube 70, which can be immersed in the supplier's container 12 or 14 for sucking out fresh coating powder. The powder pump 4 may be arranged at the beginning, at the end or in between in the fresh powder line 16 or 18 or at the upper or lower end of the powder conveying tube 70.

FIG. 1 shows as a small fresh-powder container a fresh-powder powder sack 12 in a sack receiving hopper 74. The powder sack 12 is kept in a defined form by the sack receiving hopper 74, the sack opening being located at the upper end of the sack. The sack receiving hopper 74 may be arranged on a balance or weighing sensors 76. This balance or the weighing sensors 76 may, depending on the type, produce an optical display and/or generate an electrical signal, which after deducting the weight of the sack receiving hopper 74 corresponds to the weight, and consequently also the amount, of the coating powder in the small container 12. At least one vibrating vibrator 78 is preferably arranged on the sack receiving hopper 74.

Two or more small containers 12 each in a sack receiving hopper 74 and/or two or more large containers 14, which can be alternatively used, may be provided. As a result, a quick change from one to another small container 12 or large container 14 is possible.

Although not shown in FIG. 1, it is conceivable in principle that the screening device 10 is integrated in the powder container 24. Furthermore, the screening device 10 may be omitted if the fresh powder is of sufficiently good quality. In this case, there is also the possibility of using a separate screen for screening the recovery powder of the lines 44 and 55, for example upstream or downstream of the cyclone separator 48 or in the cyclone separator 48 itself. The recovery powder also does not require a screen if the quality thereof is sufficiently good for reuse.

An exemplary embodiment of a powder container 24 of a powder supply device for a powder coating installation 1 is described below in detail with reference to the representations in FIGS. 2a and 2b. The powder container 24 shown in FIGS. 2a and 2b is suitable in particular as a component part of the powder coating installation 1 described above with reference to the representation in FIG. 1.

As shown in FIG. 2a, the exemplary embodiment is a powder container 24 which is closed or can be closed with a cover 23, the cover 23 preferably being able to be connected to the powder container 24 by way of a quickly releasable connection.

The powder container 24 represented in FIG. 2a has a substantially cuboidal powder chamber 22 for receiving coating powder. Provided in a side wall 24-3 of the powder container 24 is at least one cleaning compressed-air inlet 32-1, 32-2, to which a compressed air source 6 can be connected in a cleaning mode of the powder coating installation 1 for removing residual powder from the powder chamber 22 by way of a compressed-air line, in order to introduce cleaning compressed air into the powder chamber 22. Also provided on the already mentioned side wall 24-3 of the powder container 24 is a residual powder outlet 33, which has an outlet opening by way of which residual powder can be driven out of the powder chamber 22 in the cleaning mode of the powder coating installation 1 with the aid of the cleaning compressed air introduced into the powder chamber 22.

As revealed particularly by the representation in FIG. 2b, in the case of the exemplary embodiment of the powder container 24 altogether two cleaning compressed-air inlets 32-1, 32-2 are provided, each of the two cleaning compressed-air inlets 32-1, 32-2 having an inlet opening. On the other hand, just one residual powder outlet 33 with just one outlet opening is provided, the two inlet openings of the cleaning compressed-air inlets 32-1, 32-2 being at a distance in the vertical direction from the outlet opening of the residual powder outlet 34.

In the case of the exemplary embodiment represented in FIGS. 2a and 2b, it is provided that the inlet openings of the two cleaning compressed-air inlets 32-1, 32-2 serve in the powder coating mode of the powder coating installation 1 as powder inlet openings to which there can be connected, outside the powder chamber 22, powder supply lines 20, 20′ for the feeding, as and when required, of coating powder into the powder chamber 22. Accordingly, in the case of the embodiment represented, each cleaning compressed-air inlet 32-1, 32-2 is given the function in the powder coating mode of the powder coating installation 1 of a powder inlet 20-1, 20-2, which, as and when required, are connected in terms of flow to the powder supply lines 20, 20′. Of course, however, it is also conceivable to provide in addition to the cleaning compressed-air inlets 32-1, 32-2 separate powder inlets 20-1, 20-2.

It is also provided that, in the powder coating mode of the powder coating installation 1, the inlet opening of one of the two powder inlets 20-1, 20-2 serves for the feeding, as and when required, of fresh powder and the inlet opening of the other of the two powder inlets 20-2, 20-1 serves for the feeding, as and when required, of recovery powder. Of course, however, it is also conceivable that, in the powder coating mode of the powder coating installation 1, both recovery powder and fresh powder can be fed, as and when required, by way of the inlet opening from one and the same powder inlet 20-2, 20-1.

In the case of the embodiment represented in FIG. 2a and FIG. 2b, a fluidizing device 30 for introducing fluidized compressed air into the powder chamber 22 is preferably provided. The fluidizing compressed air may be introduced into the powder chamber 22 through an end wall, longitudinal side wall, bottom wall or top wall. According to the embodiment represented, the bottom wall 24-2 of the powder chamber 22 is formed as a fluidizing bottom. It has a multiplicity of open pores or small through-openings, through which fluidizing compressed air from a fluidizing compressed-air chamber arranged underneath the bottom wall can flow upward into the powder chamber 22, in order therein to put the coating powder into a suspended state (fluidize it) in the powder coating mode of the powder coating installation 1, in order that it can easily be sucked out with the aid of a powder discharge device. The fluidizing compressed air is fed to the fluidizing compressed-air chamber through a fluidizing compressed-air inlet.

In order that, during the operation of the fluidizing device 30, the pressure within the powder chamber 22 does not exceed a previously specified maximum pressure, the powder chamber 22 has at least one fluidizing compressed-air outlet 31 with an outlet opening for removing the fluidizing compressed air introduced into the powder chamber 22 and for bringing about a pressure equalization. In particular, the outlet opening of the at least one fluidizing compressed-air outlet 31 should be dimensioned in such a way that, during the operation of the fluidizing device 30, there is in the powder chamber 22 a positive pressure of at most 0.5 bar with respect to atmospheric pressure.

In the case of the embodiment represented in FIGS. 2a and 2b, the outlet opening of the residual powder outlet 33 is identical to the outlet opening of the fluidizing compressed-air outlet 31. Of course, however, it is also possible that the fluidizing compressed-air outlet 31 is, for example, provided in the cover 23 of the powder container 24.

As revealed particularly by the representation in FIG. 2a, in the case of the embodiment shown the fluidizing compressed-air outlet 31 has a venting line, which is connected or can be connected outside the powder chamber 22 to a rising pipe 27, in order to prevent a powder emission from the powder chamber 22 during the powder coating operation of the powder coating installation 1.

For removing the fluidizing compressed air introduced into the powder chamber 22, it is also conceivable to provide a venting line which preferably protrudes into the upper region of the powder chamber 22. The protruding end of the venting line may protrude into an intake funnel of an extraction installation. This extraction installation may be configured for example as a booster (air mover). A booster, which is also known as an “air mover”, operates on the basis of the Coanda effect and requires for its drive customary compressed air, which must be supplied in a small amount. This amount of air has a higher pressure than the ambient pressure. The booster produces in the intake funnel an air flow of high velocity, with great volume and low pressure. Therefore, a booster is particularly well suited in connection with the venting line or the fluidizing compressed-air outlet 31.

In the case of the exemplary embodiment represented in FIG. 2a, the powder container 24 has a contactlessly operating level sensor S1, S2, in order to detect the maximum permissible powder level in the powder chamber 22. It is conceivable here to provide a further level sensor, which is arranged with regard to the powder container 24 in such a way as to detect a minimum powder level and, as soon as the powder reaches or falls below this minimum level, to emit a corresponding message to a control device 3, in order to feed fresh powder or recovery powder to the powder chamber 22, preferably automatically, by way of the inlet opening of the at least one powder inlet 20-1, 20-2.

Preferably, the level sensor S1, S2 for detecting the powder level in the powder chamber 22 is a contactlessly operating level sensor and is arranged outside the powder chamber 22, separate from it. As a result, soiling of the level sensor S1, S2 is prevented. The level sensor S1, S2 generates a signal when the powder level has reached a certain height. It is also possible for a number of such powder level sensors S1, S2 to be arranged at different heights, for example for detecting predetermined maximum levels and for detecting a predetermined minimum level.

The signals of the at least one level sensor S1, S2 are preferably used for controlling an automatic powder supply of coating powder through the powder inlets 20-1, 20-2 into the powder chamber 22, in order to maintain a predetermined level or a predetermined level range therein even during the time period while the injectors 111 are sucking coating powder out of the powder chamber 22 and pneumatically conveying it to spraying devices 40 (or into other containers).

During such a powder spray coating mode, cleaning compressed air is not conducted into the powder chamber 22, or is conducted only with reduced pressure.

As revealed by the representation in FIG. 2a, in the case of the exemplary embodiment it is provided that in the bottom wall 24-2 of the powder container 24 there is provided a powder outlet 35, which can be opened with the aid of a pinch valve 21 in order, as and when required, to remove coating powder from the powder chamber 22, preferably by gravitational force. This is required in particular whenever, in the event of a change of color or powder, coating powder of the old kind is still present in the powder chamber 22.

The powder supply device shown in FIG. 2a and FIG. 2b also has at least one powder conveying device 110, in order to be able to convey coating powder by means of an injector 111, preferably a number of injectors 111, by way of powder hoses 38 to spraying devices 40 and spray it by the latter onto an object 2 to be coated. Instead of injectors 111, other types of powder conveying devices may be used, for example powder pumps.

The structure of the powder conveying device 110 used in the case of the powder supply device shown in FIG. 2a and FIG. 2b is described hereafter with reference in particular to the representations in FIGS. 3a, 3b and 4.

As represented in FIG. 2a, corresponding powder discharge openings 36 are provided in the chamber walls 24-3 and 24-4 of the powder container 24. In the case of the embodiment represented, it is provided that each of the powder discharge openings 36 is connected in terms of flow to an associated injector 111 of the powder conveying device 110, in order in the powder coating mode of the powder coating installation 1 to be able to suck coating powder out of the powder chamber 22 and feed it to the spraying devices 40. The powder discharge openings 36 preferably have an elliptical form, so that the effective area for the intake of fluidized coating powder is increased.

The powder discharge openings 36 are arranged as deeply as possible in the powder chamber 22, in order to be able as far as possible to suck out all of the coating powder from the powder chamber 22 by means of the injectors 111. The injectors 111 are preferably located at a point higher than the highest powder level and are respectively connected to one of the powder discharge openings 36 by a powder discharge or powder intake channel 100. The powder discharge openings 36 correspond here to the powder intake openings of the powder intake channels 100. The fact that the injectors 111 are arranged higher than the maximum powder level avoids the coating powder rising up out of the powder chamber 22 into the injectors 111 when the injectors 111 are not switched on.

As represented in FIG. 2b, each injector 111 has a conveying gas connection 93 for conveying gas, in particular conveying compressed air, which generates a negative pressure in a negative pressure region of the injector 111 and thereby sucks coating powder through a powder intake opening 36 and the associated powder intake channel 100 out of the powder chamber 22 and then conveys it through a jet-receiving nozzle 112 (powder output) through a powder hose 38 to a receiving point, which may be said spraying device 40 or a further powder container 24. To assist powder conveyance, the injector 111 may be provided with a metering gas or additional gas connection 94 for the feeding of metering gas or additional gas (preferably compressed air) into the stream of conveying air and powder at the powder output.

In the case of the embodiment represented in FIG. 2a and FIG. 2b, a multiplicity of powder conveying devices 110 with injectors 111 are used, the powder intake channels 100 of the multiplicity of powder conveying devices 110 being formed within two opposing side walls 24-3, 24-4 of the powder container 24. Of course, however, it is also conceivable that the powder intake channels 100 are not formed in side walls of the powder container 24 but are formed as powder intake tubes 70′.

The exact structure of a pneumatic powder conveying device 110 according to the present invention is described below with reference to the representations in FIGS. 3a and 3b.

Specifically, FIG. 3a shows an exemplary embodiment of the powder conveying device 110 according to the invention in a side view. As represented, this device has an injector 111, which has a conveying gas connection 93, which is connected or can be connected in terms of flow to a conveying gas line 101 and is intended for the regulated feeding of conveying gas, in particular conveying air. The conveying gas line 101 is represented in the pneumatic diagram according to FIG. 4.

The injector 111 of the powder conveying device 110 according to the invention is also provided with a metering gas connection 94, which, as can be seen from the pneumatic diagram according to FIG. 4, is connected or can be connected to a metering gas line 102 in order to feed metering gas, in particular metering compressed air, to the injector 111 in a regulated manner. As is generally known from the prior art, the conveying gas is fed to the injector 111 in such a way that a negative pressure region is formed in the injector 111.

The representation in FIG. 3a also reveals that the exemplary embodiment of the powder conveying device 110 according to the invention has a powder intake channel 100. In the case of the exemplary embodiment according to FIG. 3a, this powder intake channel 100 runs within a powder intake tube 70′. As already described above with reference to the representations in FIGS. 2a and 2b, it is however also conceivable to provide the powder intake channel 100 within the side wall of a powder container 24, in particular within the side walls 24-2 and 24-4.

Irrespective of whether the powder intake channel 100 is formed in a powder intake tube 70′ or in the side wall of a powder container 24, in the case of the solution according to the invention it is provided that the injector 111 is connected or can be connected in terms of flow to the powder intake channel 100, the powder intake channel 100 having at its powder input 100a a powder intake opening 36 for taking in the powder 42 to be conveyed.

The representation in FIG. 4 particularly reveals that a purging gas connection 91, which is connected or can be connected in terms of flow to a purging gas line 103, is provided between the negative pressure region of the injector 111 and the powder intake opening 36 of the powder intake channel 100, in order to feed purging gas (preferably purging compressed air) to the injector 111, as and when required, i.e. in particular in the cleaning mode.

The representation in FIG. 4 also reveals that a shut-off element 92, assigned to the purging gas connection 91, is provided between the purging gas connection 91 and the powder intake opening 36 of the powder intake channel 100. In the case of the embodiment represented, this shut-off element 92 is configured as a direction-bound non-return valve. Of course, however, it is also conceivable to form the shut-off element 92 as an activatable valve, in particular a pinch valve. In principle, the shut-off element 92 assigned to the purging gas connection 91 serves the purpose of effectively preventing purging gas from being able to escape unintentionally from the powder output opening 36 of the powder intake channel 100 when this purging gas is being fed to the injector 111 by way of the purging gas connection 91.

The representation in FIG. 3b reveals that, in the case of the exemplary embodiment, the injector 111 has a powder input 114 in the form of a pipe stub or in the form of a stub-like connection, by way of which the coating powder 42 taken in through the powder intake opening 36 of the powder intake channel 100 is fed to the injector 111. The representation in FIG. 3b also directly reveals that the purging gas connection 91 with the assigned shut-off element 92 is arranged between the powder input 114 of the injector 111 and the powder output 100b of the powder intake channel 100. In the case of the embodiment shown in FIG. 3a, the powder output 100b of the powder intake channel 100 at the same time represents the output of the powder conveying tube 70′.

As the representation in FIG. 3b reveals, it is provided in the case of the embodiment shown there of the powder conveying device 110 according to the invention that the purging gas connection 91 and the associated shut-off element 92 are formed as a common subassembly 90, which is connected releasably (here by way of a locking screw or stop bolt 115) to the powder input 114 of the injector 111. Furthermore, the subassembly 90 comprising the purging gas connection 91 and the shut-off element 92 is releasably connected to the powder output 100b of the powder conveying tube 70′ or of the powder intake channel 100 formed in the powder conveying tube 70′.

The pneumatic diagram according to FIG. 4 reveals that the conveying gas connection 93 is assigned a shut-off element 95 in the form of a direction-bound non-return valve, in order to shut off possibly occurring air flows from the injector 111 into the conveying gas line 101 which is connected or can be connected to the conveying gas connection 93. In the same way, the metering gas connection 94 is also assigned a shut-off element 96 (in the case of the embodiment represented in FIG. 4 in the form of a direction-bound non-return valve), in order likewise to shut off gas flows from the injector 111 into the metering gas line 102 which is connected or can be connected to the metering gas connection 94.

FIGS. 3a, 3b reveal that the injector 111 has a jet-receiving nozzle 112, which, as seen in the powder conveying direction, is downstream of the negative pressure region of the injector 111. Specifically, in the case of the embodiment represented, the jet-receiving nozzle 112 is releasably fastened to the injector 111 with the aid of a union nut 113. The jet-receiving nozzle 112, formed as an elongate hollow body, forms in its interior a so-called jet-receiving channel, in which the fluidized and conveyed powder-air mixture is conducted. After inserting the jet-receiving nozzle 112 into the injector 111, opposite the jet-receiving channel in the axial direction there is a nozzle arrangement, through which the conveying air is forced into the jet-receiving nozzle 112. Owing to the relatively small diameter of the nozzle arrangement, there forms a stream of air of high velocity, whereby a negative pressure forms in a directly adjacent negative pressure region, which is in connection with the powder container 24 by way of the powder intake channel 100. On account of the negative pressure, fluidized coating powder is conveyed out of the powder container 24 in the powder intake channel 100 in the direction of the jet-receiving nozzle 112 and conducted through the latter to a powder line 38. The powder line 38 is connected to a spraying device 40.

The representations in FIGS. 3a, 3b and 4 also reveal that, in the case of the powder conveying device 110 represented by way of example there, a fluidizing gas connection 97, which is connected or can be connected in terms of flow to a fluidizing gas line 105, is provided between the shut-off element 92, assigned to the purging gas connection 91, and the powder intake opening 36 of the powder intake channel 100. By way of this fluidizing gas connection 97, fluidizing gas, in particular fluidizing air, can be fed as and when required to the powder intake channel 100. Specifically, in the case of the exemplary embodiment represented, it is provided that the fluidizing gas connection 97 is arranged at the powder output 100b of the powder intake channel 100. Of course, however, other positions also come into consideration for the fluidizing gas connection 97.

It is described below with reference to the pneumatic schematic diagram according to FIG. 4 how, in the case of the exemplary embodiment, the injector 111 of the powder conveying device 110 is operated.

Specifically, the diagram according to FIG. 4 reveals that the conveying gas line 101, connected to the conveying gas connection 93 of the injector 111, is provided with an adjustable pressure setting device M1, in order to be able to set the amount of conveying gas per unit of time that is fed as a maximum to the conveying gas connection 93. In the same way, the metering gas line 102, connected to the metering gas connection 94 of the injector 111, is provided with an adjustable pressure setting device M2 for setting the amount of metering gas per unit of time that is fed as a maximum to the metering gas connection 94. By suitable activation of the pressure setting device M1 assigned to the conveying gas line 101 and the pressure setting device M2 assigned to the metering gas line 102 it can be ensured that, in the powder coating mode, the total amount of air that transports the coating powder always assumes a constant value. By way of the pressure setting device M1 assigned to the conveying gas line 101, the pressure can be changed, and consequently so can the amount of conveying air fed per unit of time to the conveying gas connection 93, as a result of which the amount of coating powder conveyed per unit of time can be set.

Since—as already stated at the beginning—the conveying rate of the injector 111 is dependent on the level of the negative pressure produced by the conveying air in the negative pressure region 5 of the injector 111, with constant or variable conveying air the conveying rate of the injector 111 can also be regulated by introducing metering air into the negative pressure region of the injector 111, in order in this way to change the level of the negative pressure to correspond to the desired amount of powder conveyed. However, it must be taken into consideration that the total amount of air that must be fed in the powder conveying mode to the injector 111 by way of the conveying gas connection 92 and the metering gas connection 94 must neither become too small nor exceed a maximum value in order for reproducible powder coating to be possible. Accordingly, the pressure setting device M2 assigned to the metering gas line 102 must be set correspondingly.

The pneumatic diagram according to FIG. 4 also reveals that the fluidizing gas line 105, connected in terms of flow to the fluidizing gas connection 97, is likewise provided with an adjustable pressure setting device M4. In this way, the amount of fluidizing gas fed per unit of time to the fluidizing gas connection 97 is set.

The purging gas line 103, connected to the purging gas connection 91, has a valve V2, which in the case of the embodiment represented is a spring-loaded 2/2-way valve. This valve V2 can be activated by a control device 35 (cf. FIG. 1) in order to feed purging gas in a pulsed manner to the purging gas connection 91, in particular in the cleaning mode of the powder conveying device 110. The way in which the purging gas is fed to the purging gas connection 91 in a pulsed manner is to be described hereafter with reference to the representations in FIGS. 5 and 6.

In the same way, a further valve V1 is provided in the form of a spring-loaded 2/2-way valve. By way of this valve V1, the conveying gas line 101, the metering gas line 102 and an electrode purging gas line 104 are connected to the main line 106, the main line 106 being connected to the system pressure by way of a filter arrangement and a pressure controller. The electrode purging gas line 104 leads (although not explicitly represented) to the spraying device 40, which is connected by way of the powder line 38 to the injector 111, in order to feed electrode purging gas, in particular electrode purging air, to the powder device 40 and in this way clean the electrodes possibly provided at the spraying device 40 for the electrostatic charging of the sprayed coating powder and keep them free from contamination.

The already mentioned valve V1, with which the conveying gas line 101 and the metering gas line 102 are connected in terms of flow, can be activated by the control device 35 (cf. FIG. 1) in such a way as to feed conveying gas and metering gas in a pulsed manner to the conveying gas connection 93 and the metering gas connection 94, respectively, in particular in the cleaning mode of the powder conveying device 110.

An exemplary embodiment of the cleaning method according to the invention is described below with reference to the representations in FIGS. 5 and 6. The cleaning method is suitable in particular for effectively cleaning a powder conveying device 110 of the type described above in the event of a change of color or powder.

As the time sequence diagram according to FIG. 5 reveals, as soon as the cleaning method is initiated, first metering gas, in particular metering compressed air, is continuously fed to the injector 111 by way of the metering gas connection 94 of the injector 111, in order in this way to empty the powder line 38 connected in terms of flow to the injector 111. Alternatively or in addition to this, it is also conceivable that, to empty the powder line 38, conveying gas, in particular conveying compressed air, is fed to the injector 111 in a continuous manner by way of the conveying gas connection 93 of the injector 111. For emptying the powder line 38, the valve V2, provided in the purging gas line 103, is opened and the valve V1, assigned to the metering gas line 102 and the conveying gas line 101, is closed, the pressure setting device M2, assigned to the conveying gas line 102, isolating the metering gas connection 94 of the injector 111 in terms of flow from the valve V1.

The emptying of the powder line 38 is followed by the actual cleaning, in that purging gas is fed in a pulsed manner by way of the purging gas connection 91 of the injector 111, by suitable activation of the valve V2. At the same time as this, by suitable activation of the valve V1 and the pressure setting devices M1 and M2, metering gas and conveying gas are fed to the injector 111 in a pulsed manner by way of the metering gas connection 94 and the conveying gas connection 93, respectively. The pulsed feeding of the purging gas and the pulsed feeding of the metering and conveying gas thereby take place in phase, although the lengths of the pulses during which the purging gas is fed and the lengths of the pulses during which the metering gas and the conveying gas are fed are different. Specifically, the pulse lengths for the feeding of the purging gas are longer than the pulse lengths for the feeding of the metering gas and conveying gas.

The sequence diagram according to FIG. 5 reveals that the actual cleaning of the system is divided into different phases. During the first phase, the purging gas as well as the metering gas and the conveying gas are fed to the injector 111 with a relatively high frequency. During the then-following second phase, the frequency is lowered. In the subsequent third phase, the pulsed feeding of the purging gas as well as of the metering gas and the conveying gas takes place again with a higher frequency. The concluding final phase is relatively short, only a single purging-gas, metering-gas and conveying-gas pulse being respectively introduced into the system.

FIG. 5 also reveals that, in the cleaning mode, the pressure setting device M3, which is assigned to the electrode purging gas line 104, is also opened, at least after the emptying of the powder line 38, in order to bring about cleaning of the electrodes provided at the spraying device 40.

According to one aspect of the present invention, the time sequence represented by way of example in FIG. 5 is carried out automatically, in that the control device 35 (cf. FIG. 1) suitably activates the corresponding valves V1, V2 and pressure setting devices M1, M2, M3. Such an automatic cleaning process is preferably initiated by manual actuation of a trigger, which is arranged in an advantageous way at a spraying device 40 connected in terms of flow to the injector 111 by way of the powder line 38.

In FIG. 6, the time sequence of a cleaning procedure in which manual cleaning is performed is represented. After the initiation of the cleaning process, preferably likewise by manual actuation of a trigger, first the powder line 38 is emptied—as also in the case of the sequence diagram according to FIG. 5. This takes place in turn by metering gas, in particular metering compressed air, being fed continuously to the injector 111 by way of the metering gas connection 94 of the injector 111, in order in this way to empty the powder line 38 connected in terms of flow to the injector 111. Alternatively or an addition to this, it is once again conceivable that, to empty the powder line 38, conveying gas, in particular conveying compressed air, is fed to the injector 111 in a continuous manner by way of the conveying gas connection 93 of the injector 111. For emptying the powder line 38, the valve V2, provided in the purging gas line 103, is opened and the valve V1, assigned to the metering gas line 102 and the conveying gas line 101, is closed, the pressure setting device M2, assigned to the conveying gas line 102, isolating the metering gas connection 94 of the injector 111 in terms of flow from the valve V1.

In the case of the sequence diagrams represented in FIGS. 5 and 6, the process for emptying the powder line 38 is already completed after about 2 seconds.

As also in the case of the automatic cleaning according to the sequence diagram represented in FIG. 5, in the case of the manual cleaning according to the sequence diagram represented in FIG. 6, after the emptying of the powder line 38, purging gas, metering gas and/or conveying gas is fed to the system in a pulsed manner. In the case of the manual cleaning sequence according to FIG. 6, on the other hand, the pulsed feeding of the purging gas, metering gas and conveying gas does not take place automatically after a specified or specifiable sequence of events. Rather, in the case of the manual cleaning, purging gas is fed to the injector 111 whenever the trigger, for example the gun trigger, is manually actuated. The actuation of the gun trigger is also accompanied at the same time by the feeding of metering and conveying gas to the injector 111, although—as the sequence diagram according to FIG. 6 reveals—this may take place after a certain time delay and then ceases immediately when the gun trigger is no longer being actuated.

The feeding of metering and conveying gas to the injector 111, which—as represented in FIG. 6—takes place with a certain time delay with regard to the feeding of the purging gas, or which may however also take place at the same time as the feeding of the purging gas, and the feeding of the purging gas, dependent on the manual actuation of the trigger, are also coordinated by the control device 35 (cf. FIG. 1) in the case of the manual cleaning process, to be precise by the corresponding valves V1, V2 and pressure setting devices M1, M2, M3 being suitably activated.

It is preferred if the pneumatic powder conveying device is designed for optionally carrying out automatic or manual cleaning. It is conceivable, for example, that automatic cleaning is carried out as standard, if for example a suitable trigger is manually actuated, the system going over from the automatic cleaning mode that is set as standard into the manual cleaning mode if the trigger is actuated once again after initiation of the cleaning process within a previously specified or specifiable time. For example, a comparison of FIGS. 5 and 6 shows that, up until the repeated pulling of the trigger, both cleaning processes proceed in accordance with the same pattern in the sequence diagram according to FIG. 6. Only when there is renewed actuation of the trigger does the system detect that manual cleaning is desired and from then on changes from the automatic cleaning mode to the manual cleaning mode, in which the feeding of purging, metering and/or conveying gas to the injector 111 does not take place after a previously specified sequence of events but in dependence on the manual actuation of the trigger.

The system preferably switches over automatically again into the coating mode, in which the feeding of purging gas to the injector 111 is interrupted, if i) the automatic cleaning process has been completed or ii) if, in the manual cleaning mode, the trigger is not actuated again for a previously specified or specifiable time period.

The invention is not restricted to the embodiments described above with reference to the drawings, but is made up of all the features disclosed herein considered together.

1. A device for pneumatically conveying powder or powdered material, in particular coating powder, the device having the following:
at least one injector, which has a conveying gas connection, which is connected or can be connected in terms of flow to a conveying gas line and is intended for the regulated feeding of conveying gas, in particular conveying air, and has a metering gas connection, which is connected or can be connected to a metering gas line and is intended for the regulated feeding of metering gas, in particular metering air, the conveying gas being fed to the injector in such a way that a negative pressure region is formed in the injector; and
a powder intake channel, which is connected or can be connected in terms of flow to the injector and has at its powder input a powder intake opening for taking in the powder to be conveyed,
characterized
in that a purging gas connection, which is connected or can be connected in terms of flow to a purging gas line, is provided between the negative pressure region of the injector and the powder intake opening of the powder intake channel for the feeding, as and when required, of purging gas, in particular purging air; and
in that an activatable or direction-bound shut-off element, which is assigned to the purging gas connection, is provided between the purging gas connection (91) and the powder intake opening of the powder intake channel to prevent purging gas from being able to escape from the powder output opening of the powder intake channel.

2. The powder conveying device as claimed in claim 1,
the injector having a powder input, by way of which the coating powder taken in through the powder intake opening of the powder intake channel (100) is fed to the injector, and
the purging gas connection with the shut-off element being arranged between the powder input of the injector and the powder output of the powder intake channel.

3. The powder conveying device as claimed in claim 2,
the purging gas connection and the shut-off element being formed as a subassembly, which is preferably releasably connected to the powder input of the injector; and/or
the purging gas connection and the shut-off element being formed as a subassembly, which is preferably releasably connected to the powder output of the powder intake channel.

4. The powder conveying device as claimed in claim 1,
the shut-off element being formed as a direction-bound non-return valve, which shuts off gas flow(s) from the purging gas connection in the direction of the powder output opening of the powder intake channel; or
the shut-off element being formed as an activatable valve, in particular a pinch valve, for the shutting off, as and when required, of gas flow(s) from the purging gas connection in the direction of the powder output opening of the powder intake channel.

5. The powder conveying device as claimed in claim 1,
the conveying gas connection being assigned a shut-off element, in particular a direction-bound non-return valve, for shutting off gas flow(s) from the injector into the conveying gas line, which is connected or can be connected to the conveying gas connection; and/or
the metering gas connection being assigned a shut-off element, in particular a direction-bound non-return valve, for shutting off gas flow(s) from the injector into the metering gas line, which is connected or can be connected to the metering gas connection.

6. The powder conveying device as claimed in claim 1,
the conveying gas line, which is connected or can be connected to the conveying gas connection, being provided with an adjustable pressure setting device for setting the amount of conveying gas per unit of time that is fed as a maximum to the conveying gas connection; and/or
the metering gas line, which is connected or can be connected to the metering gas connection, being provided with an adjustable pressure setting device for setting the amount of metering gas per unit of time that is fed as a maximum to the metering gas connection.

7. The powder conveying device as claimed in claim 1,
a valve, in particular a spring-loaded 2/2-way valve, being provided, which valve is connected or can be connected in terms of flow to the purging gas line and can be activated by a control device in such a way as to feed purging gas to the purging gas connection in a pulsed manner, in particular in the cleaning mode of the powder conveying device.

8. The powder conveying device as claimed in claim 1,
at least one valve, in particular a spring-loaded 2/2-way valve, being provided, which valve is connected or can be connected in terms of flow to the conveying gas line and/or the metering gas line and can be activated by a control device in such a way as to feed conveying gas or metering gas to the conveying gas connection (93) and/or the metering gas connection in a pulsed manner, in particular in the cleaning mode of the powder conveying device.

9. The powder conveying device as claimed in claim 1,
a fluidizing gas connection, which is connected or can be connected in terms of flow to a fluidizing gas line, being provided between the shut-off element assigned to the purging gas connection and the powder intake opening of the powder intake channel for the feeding, as and when required, of fluidizing gas, in particular fluidizing air, to the powder intake channel.

10. The powder conveying device as claimed in claim 9,
the fluidizing gas connection being provided at the powder output of the powder intake channel.

11. The powder conveying device as claimed in claim 1,
the at least one injector having a nozzle arrangement, through which the conveying gas fed by way of the conveying gas connection flows in such a way that the negative pressure region is formed at the mouth of the nozzle arrangement, and the metering gas connection being arranged and formed in such a way that the metering gas fed to the injector is conducted into the negative pressure region for setting the amount of powder or powdered material conveyed per unit of time.

12. The powder conveying device as claimed in claim 1,
the injector having a jet-receiving nozzle, which is downstream of the negative pressure region, seen in the direction of powder conveyance, the jet-receiving nozzle being connected or able to be connected in terms of flow by way of a powder line to a spraying device.

13. A powder supply device for a powder coating installation, the powder supply device having the following:
at least one pneumatic powder conveying device as claimed in claim 1; and
at least one powder container with a powder chamber for coating powder,
the powder intake opening of the powder intake channel, which is connected or can be connected to the at least one injector of the powder conveying device, opening out in the powder chamber.

14. The powder supply device as claimed in claim 13,
the at least one injector of the powder conveying device being arranged at a point which is higher than the highest level of powder that can be set in the powder chamber, and
the powder intake channel being formed within a side wall of the powder container; or
the powder intake channel being formed within a powder tube protruding into the powder chamber.

15. A method for cleaning a pneumatic powder conveying device, in particular in the event of a change of colour or powder, the powder conveying device that is to be cleaned having at least one injector with a conveying gas connection (93), a metering gas connection (94) and a purging gas connection, and the method having the following method steps:
a) continuous feeding of metering gas, in particular metering air, by way of the metering gas connection of the injector and/or continuous feeding of conveying gas, in particular conveying air, by way of the conveying gas connection of the injector for a previously specified or specifiable time period for emptying a powder line connected in terms of flow to the injector; and
b) pulsed feeding of purging gas by way of the purging gas connection of the injector after elapse of the previously specified or specifiable time period; and
c) pulsed feeding of metering gas and/or conveying gas by way of the metering gas connection and/or conveying gas connection of the injector.

16. The method as claimed in claim 15,
the cleaning method being initiated by manual actuation of a trigger, which is arranged at a spraying device connected in terms of flow to the injector by way of the powder line.

17. The method as claimed in claim 15,
method steps b) and c) being carried out at the same time.

18. The method as claimed in claim 15,
the pulsed feeding of the purging gas and the pulsed feeding of the metering gas and/or conveying gas taking place in phase in method steps b) and c).

19. The method as claimed in claim 18,
the lengths of the pulses during which the purging gas is fed and the lengths of the pulses during which the metering gas and/or conveying gas is fed being different in method steps b) and c), the pulse lengths for the feeding of the purging gas preferably being longer than the pulse lengths for the feeding of the metering gas and/or conveying gas.

20. The method as claimed in claim 15,
method steps b) and c) being divided into at least two phases, which differ in the frequency with which the purging gas and the metering gas and/or conveying gas are fed.

21. The method as claimed in claim 15,
the method also having the following method step:
d) pulsed feeding of electrode purging gas to a spraying device connected in terms of flow to the injector by way of the powder line.

22. The method as claimed in claim 15,
the cleaning method optionally being carried out automatically.
